(19) United States
(12) Patent Application Publication
(10) Pub. No.: US 2012/0017414 A1
(43) Pub. Date: Jan. 26, 2012

(54) CABINET DRAWER SUPPORT SYSTEM

(76) Inventor: Anthony J. Cerniglia, Wauconda, IL (US)

(21) Appl. No.: 13/188,567

(22) Filed: Jul. 22, 2011

Related U.S. Application Data
(60) Provisional application No. 61/367,190, filed on Jul. 23, 2010.

(51) Int. Cl. B23P 11/00; B23P 19/00

(52) U.S. Cl. 29/428; 29/700

(57) ABSTRACT

A system for securely installing one or more drawers or shelves in a cabinet. The system includes a set of adjustable stretcher bar housing assemblies having at least one pair of adjustable stretcher bar housing assemblies. Each adjustable stretcher bar housing assembly includes a first face adapted to contact one of a rear wall or a face frame of a cabinet, and a second face longitudinally spaced from the first face and adapted to contact the other of the rear wall or the face frame of the cabinet. The system further includes an adjustment system having a primary translation generating mechanism and a movable adjustment member. The primary translation generating mechanism causes the moveable adjustment member to axially extend until at least one of the first face or the second face contacts one of the face frame or the rear wall of the cabinet.

### REFERENCE TO RELATED APPLICATIONS

This disclosure is the non-provisional of U.S. Provisional Patent Application No. 61/367,190, filed Jul. 23, 2010, which is incorporated herein by reference. This application claims the benefit of the filing date of U.S. Provisional Patent Application No. 61/367,190 as to all subject matter disclosed therein.

### FIELD OF THE DISCLOSURE

This disclosure relates generally to cabinet systems and, more specifically, to a system and method for adapting a face-frame cabinet to accommodate one or more sliding drawers or shelves in a stable and secure manner without the need for tools.

### SUMMARY OF THE DISCLOSURE

A system for securely installing one or more slideable drawers or shelves in a face-frame cabinet at selectable heights includes a set of adjustable stretcher bar housing assemblies, each pair of housing assemblies securely engaging the front and rear faces of the face-frame cabinet via an adjustment mechanism including a primary translation generating mechanism. The primary translation generating mechanism imparts axial translation of a movable adjustment member including an engagement pad associated with the adjustable stretcher bar housing assembly with an adjacent rear or front wall of the face-frame cabinet. The adjustment mechanism additionally includes a secondary translation mechanism used to create the additional translation of the movable adjustment member when a locking lever of a locking mechanism is moved to its stowed position. In one embodiment, the secondary translation mechanism includes a stepped cam track assembly. In an alternate embodiment, the secondary translation mechanism includes a ball joint-based translation-generating mechanism.

Each adjustable stretcher bar housing assembly includes one or more vertically-open, outwardly-extending U-shaped channels including one or more hanger hooks. The hanger hooks engage complementary upright standard mounting bar windows or openings provided along an upright standard mounting bar. Once upright standard mounting bars are secured in a lowermost pair of the adjustable stretcher bar housing assemblies, a subsequent pair of adjustable stretcher bar housing assemblies may be mounted at a desired height (by interlocking the hanger hooks of the subsequent pair of adjustable stretcher bar housing assemblies in the upright standard mounting bar windows at the desired height). The upright standard mounting bars may be adapted such that a lowermost end thereof, to be received in one of the lowermost adjustable stretcher bar housing assemblies, avoids contact with the hanger hooks in the U-shaped channels, such that the upright standard mounting bars may be installed from above the lowermost adjustable stretcher bar housing assemblies, after securement of the adjustable stretcher bar housing assemblies in the cabinet.

The manner in which these and other aspects of the present disclosure is achieved is described with reference to the drawing figures and the following detailed description of the preferred embodiments.

### DESCRIPTION OF THE DRAWINGS

FIG. 1 is a front perspective view of a cabinet with adjustable stretcher bar housing assemblies installed, wherein a top pair of adjustable stretcher bar housing assemblies is without drawer slides attached, the middle pair of adjustable stretcher bar housing assemblies has drawer slide assemblies attached, and the bottom pair of adjustable stretcher bar housing assemblies has drawer slide assemblies attached and a drawer slidingly engaged with the drawer slide assemblies;

FIG. 2 is a right cross-section view of the cabinet of FIG. 1 with adjustable stretcher bar housing assemblies installed;

FIG. 3 is a perspective view of an adjustable stretcher bar housing assembly of the present disclosure;

FIG. 4 is an exploded perspective view of the adjustable stretcher bar housing assembly illustrated in FIG. 3;

FIG. 5 is a right side view of the adjustable stretcher bar housing assembly illustrated in FIG. 3 with a thumbwheel, a locking lever, and a movable adjustment member thereof in their stowed positions;

FIG. 6 is a right side view of the adjustable stretcher bar housing assembly illustrated in FIG. 5 with its thumbwheel and locking lever in their up positions;

FIG. 7 is a right side view of the adjustable stretcher bar housing assembly illustrated in FIG. 6 illustrating rotation of the adjustable stretcher bar housing assembly's thumbwheel and the resulting translation of the adjustable stretcher bar housing assembly's movable adjustment member;

FIG. 8 is a right side view of the adjustable stretcher bar housing assembly illustrated in FIG. 7 illustrating the thumbwheel in the stowed position and the resulting translation of the adjustable stretcher bar housing assembly's movable adjustment member when the locking lever is moved to its stowed position;

FIG. 9 is a right cross-section view, partially broken away, of one embodiment of the mechanism that imparts translation of the adjustable stretcher bar housing assembly's movable adjustment member when the locking lever is moved from an initial position to its stowed position;

FIG. 10 is a right cross-section view, partially broken away, of another embodiment of the mechanism that imparts translation of the adjustable stretcher bar housing assembly's movable adjustment member when the locking lever is moved to its stowed position;

FIG. 11 is a front perspective view of the adjustable stretcher bar housing assembly illustrated in FIG. 3, partially broken away, illustrating internal components involved in translation of the movable adjustment member;

FIG. 12 is a left side view, partially broken away, of the adjustable stretcher bar housing assembly illustrated in FIG. 3, partially broken away, illustrating internal components of an alternate embodiment of a mechanism involved in translation of the movable adjustment member;

FIG. 13 is a perspective view, partially broken away, of the translation and locking mechanism of the alternate embodiment of a mechanism involved in translation of the movable adjustment member, as illustrated in FIG. 12;

FIG. 14 is right side view, partially broken away, of a binding member used in the translation of the movable adjustment member according to the mechanism involved in translation of the movable adjustment member as illustrated in FIG. 12;

FIG. 15 is right side view, partially broken away, of a locking member used in the alternate embodiment of the mechanism involved in translation of the movable adjustment member as illustrated in FIG. 12;

FIG. 16 is a rear perspective view of the adjustable stretcher bar housing assembly illustrated in FIG. 3 illustrating one embodiment of a rear mounting pad of the adjustable stretcher bar housing assembly of the present disclosure;

FIG. 17 is a perspective view of one embodiment of a front mounting pad attached to the movable adjustment member of the adjustable stretcher bar housing assembly illustrated in FIG. 3, wherein the front mounting pad is comprised of a resilient material;

FIG. 18 is a perspective view of another embodiment of the front mounting pad attached to the movable adjustment member of the adjustable stretcher bar housing assembly illustrated in FIG. 3, wherein the front mounting pad includes a plurality pointed protrusions;

FIG. 19 is a perspective view of yet another embodiment of the front mounting pad attached to the movable adjustment member of the adjustable stretcher bar housing assembly illustrated in FIG. 3, wherein the front mounting pad includes a plurality of pointed protrusions embedded inside of a resilient material;

FIG. 20 is a perspective view of still another embodiment of the front mounting pad attached to the movable adjustment member of the adjustable stretcher bar housing assembly illustrated in FIG. 3, wherein the front mounting pad is curved to facilitate securement of the pad to planer surfaces within a cabinet notwithstanding the presence of curved obstructions in the cabinet;

FIG. 21 is a front view of the adjustable stretcher bar housing assembly illustrated in FIG. 3 with a drawer slide attached to the adjustable stretcher bar housing assembly and the drawer slide substantially adjacent to the adjustable stretcher bar housing assembly;

FIG. 22 is a front view of the adjustable stretcher bar housing assembly illustrated in FIG. 3 with a drawer slide secured to the adjustable stretcher bar housing assembly, the drawer slide secured inwardly of the adjustable stretcher bar housing assembly;

FIG. 23 is a perspective view, partially broken away, of a portion of the adjustable stretcher bar housing assembly illustrated in FIG. 3 used at the bottom of a cabinet with an upright, vertically disposed standard mounting bar secured in a vertical channel of the adjustable stretcher bar housing assembly;

FIG. 24 is a perspective view, partially broken away, of a lowermost end of an upright vertically disposed standard mounting bar;

FIG. 25 is a perspective view, partially broken away, of a hanger bracket of the adjustable stretcher bar housing assembly illustrated in FIG. 3;

FIG. 26 is a right side view, partially broken away, of a portion of the adjustable stretcher bar housing assembly illustrated in FIG. 3 used at a location other than at the bottom, with an outwardly projecting hanger bracket of the vertical channel engaged with an upright standard mounting bar;

FIG. 27 is a front cross-section view, partially broken away, of a portion of the adjustable stretcher bar housing assembly illustrated in FIG. 3 with its hanger bracket engaged with an upright, vertically disposed standard mounting bar; and

FIG. 28 is a perspective view of the adjustable stretcher bar housing assembly illustrated in FIG. 3 with a protruding stabilizing member secured to a lower portion of the adjustable stretcher bar housing assembly.

### DETAILED DESCRIPTION OF THE PREFERRED EMBODIMENTS

An adjustable stretcher bar housing assembly according to a preferred embodiment of the present disclosure will be described with reference to the accompanying drawings.

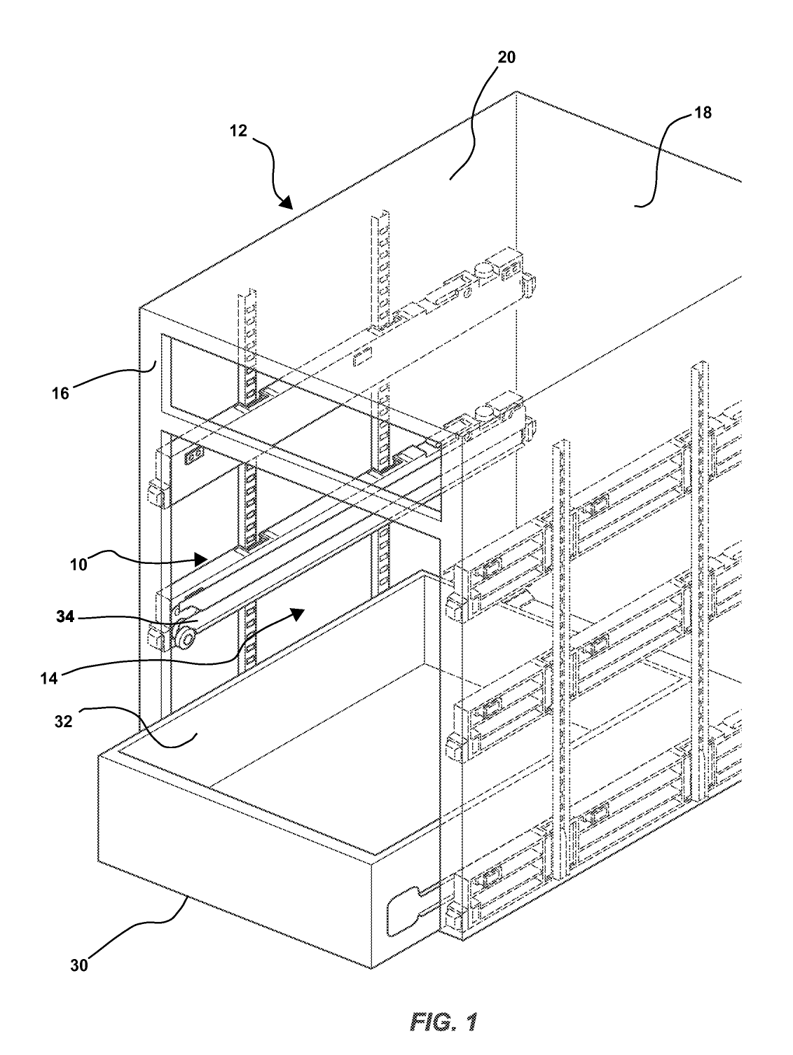

The adjustable stretcher bar housing assembly of the present disclosure is installed into a face-frame cabinet 12, as illustrated in FIG. 1, in order to provide a height-adjustable apparatus that may be useful for installing a sliding drawer 30 or shelf (not shown). The adjustable stretcher bar housing assembly 10 is axially adjustable to allow it to fit within the different internal cabinet dimensions produced by cabinet manufacturers.

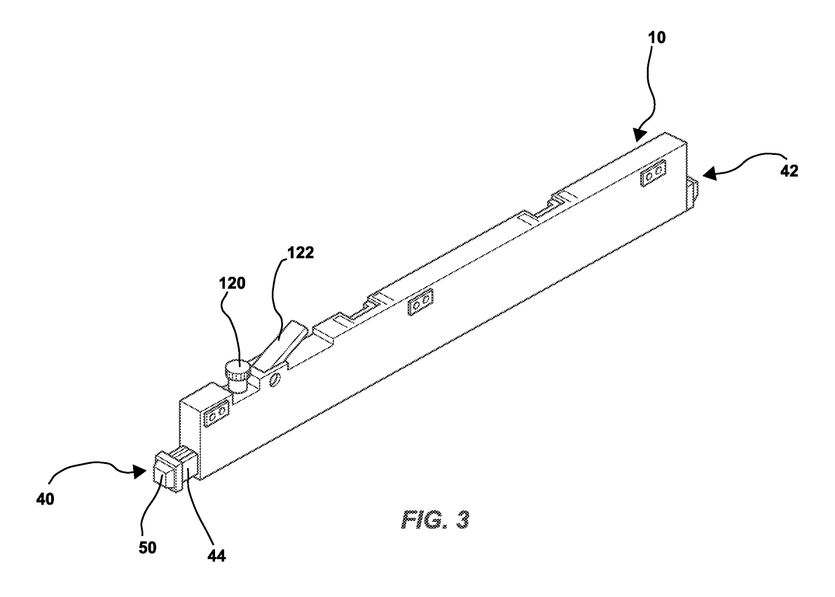

A beneficial aspect of the system and method of the present disclosure is that they facilitate installation of sliding cabinet drawers and shelves into a face-frame cabinet 12 in a tool-free manner without the need to make permanent modifications (e.g., drilling holes) to the cabinet 12. The adjustable stretcher bar housing assembly 10, as illustrated in FIG. 3, is adjusted such that a first face 40 of the adjustable stretcher bar housing assembly 10 makes contact with a cabinet rear wall 18 and a second face 42 of the adjustable stretcher bar housing assembly 10 makes contact with a cabinet face frame 16. The second face 42 is longitudinally spaced from the first face 40 of the adjustable stretcher bar housing assembly 10. This adjustment places the adjustable stretcher bar housing assembly 10 in compression within the cabinet 12.

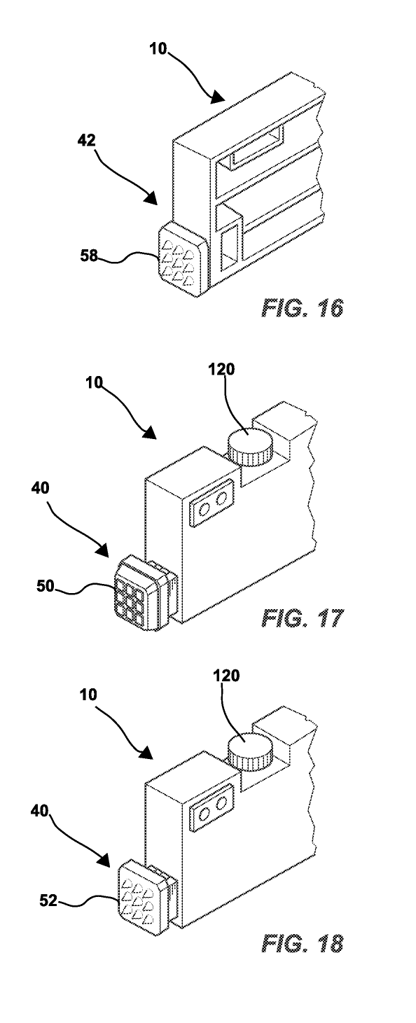

When the adjustable stretcher bar housing 10 is in compression within the cabinet 12, friction between the first face 40 of the adjustable stretcher bar housing assembly 10 (e.g., a mounting pad with resilient material 50 as illustrated in FIG. 17) and the cabinet rear wall 18 and the second face 42 of the adjustable stretcher bar housing assembly 10 (e.g., a mounting pad 58 as illustrated in FIG. 16) and the cabinet face frame 16 helps to prevent translation or rotation of the adjustable stretcher bar housing assembly 10. Because a compressive force holds the adjustable stretcher bar housing assembly 10 into place, there is no need for more permanent attachment methods (such as screws, bolts, or other fasteners).

In accordance with the present disclosure, the adjustable stretcher bar housing assembly 10 may also be installed such that the first face 40 of the adjustable stretcher bar housing assembly 10 makes contact with the cabinet face frame 16 and the second face 42 makes contact with the cabinet rear wall 18.

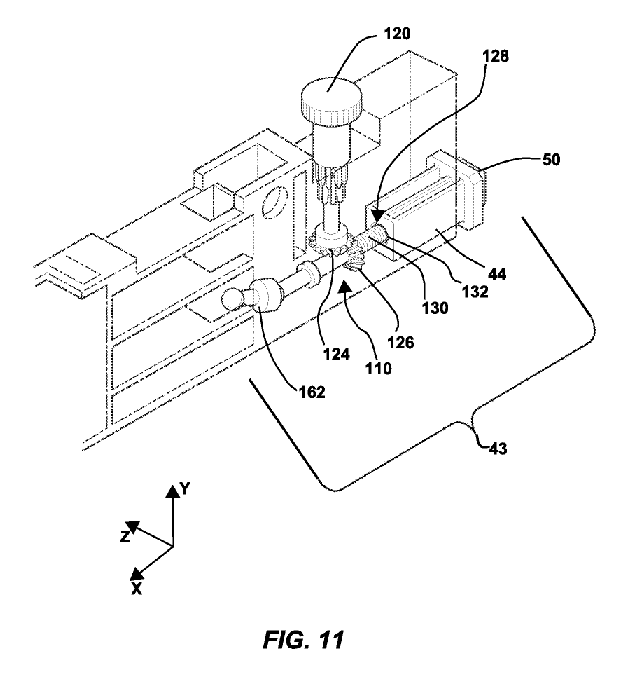

In order to install the adjustable stretcher bar housing assembly 10 of the present disclosure, the adjustable stretcher bar housing assembly 10 is placed horizontally in the bottom of the cabinet 12 such that the adjustable stretcher bar housing assembly 10 is juxtaposed with a cabinet sidewall 20. To secure the adjustable stretcher bar housing assembly 10 within the face frame cabinet 12, an adjustment system 43, as illustrated in FIG. 11, is employed. The adjustment system 43 may take the form of the combination of at least one of a telescopically mounted thumbwheel 120, as illustrated in FIG. 6, and an adjustable locking lever 122, as also illustrated in FIG. 6.

In accordance with the present disclosure, a second, paired adjustable stretcher bar housing assembly 10 is installed adjacent the opposite sidewall of the cabinet sidewall 20 and is secured in the same manner used to secure the first adjustable stretcher bar housing assembly 10.

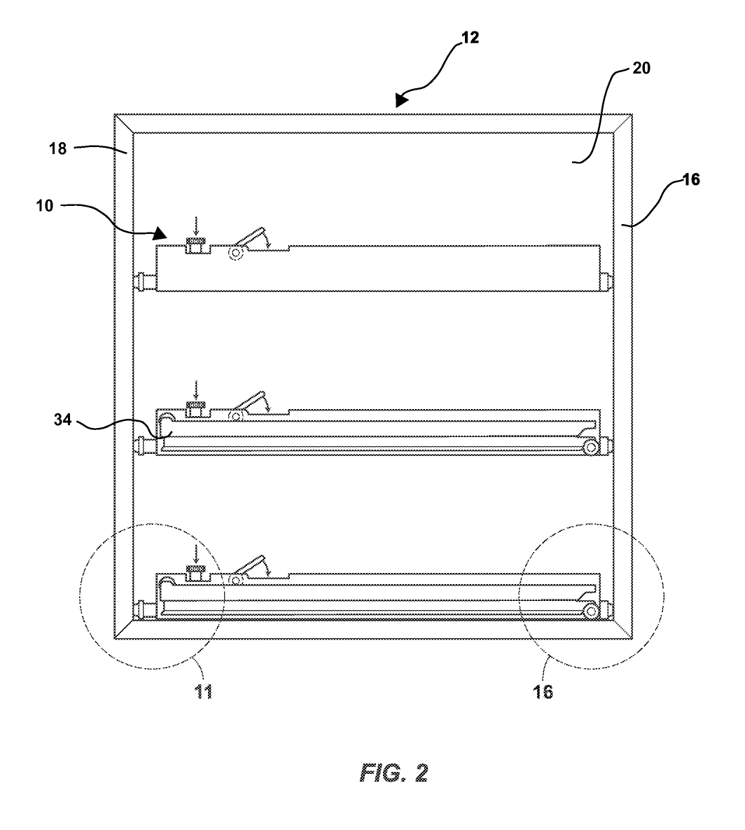

In order to continue installing the adjustable stretcher bar housing assembly 10 with an adjustment system 43 that includes both the telescopically mounted thumbwheel 120 and the adjustable locking lever 122, the thumbwheel 120 and the locking lever 122 are extended (e.g. raised) to the positions illustrated in FIG. 6. As illustrated in FIG. 7, the thumbwheel 120 is then rotated in a first direction that causes at least one of the first face 40 or the second face 42 of the adjustable stretcher bar housing assembly 10 to translate longitudinally or in a direction substantially parallel to the X axis as defined in FIG. 7 until one of the first face 40 or the second face 42 of the adjustable stretcher bar housing assembly 10 makes contact with the cabinet face frame 16 and the other of the first face 40 or the second face 42 of the adjustable stretcher bar housing assembly 10 makes the cabinet rear wall 18, as illustrated in FIG. 2.

As illustrated in FIG. 11, translation of the at least one of the first face 40 or the second face 42 of the adjustable stretcher bar housing assembly 10 may be imparted by a primary translation generating mechanism 110 linking the telescopically mounted thumbwheel 120 to a movable adjustment member 44. The movable adjustment member 44 is then caused to extend axially until one of the first face 40 or the second face 42 of the adjustable stretcher bar housing assembly 10 makes contact with the cabinet face frame 16, and the other of the first face 40 or the second face 42 of the adjustable stretcher bar housing assembly 10 makes the cabinet rear wall 18.

The primary translation generating mechanism 110 may take a variety of forms. For example, as also illustrated in FIG. 11, the translation generating mechanism may take the form of a bevel gear pair connected to a screw joint 128, wherein the screw joint 128 comprises a threaded end 130 and a threaded socket 132.

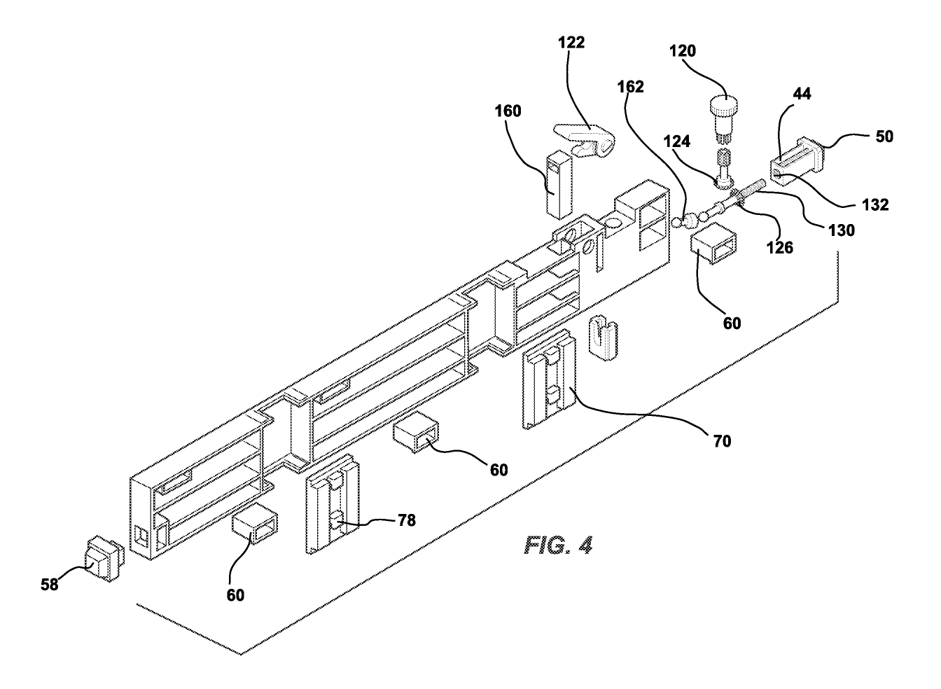

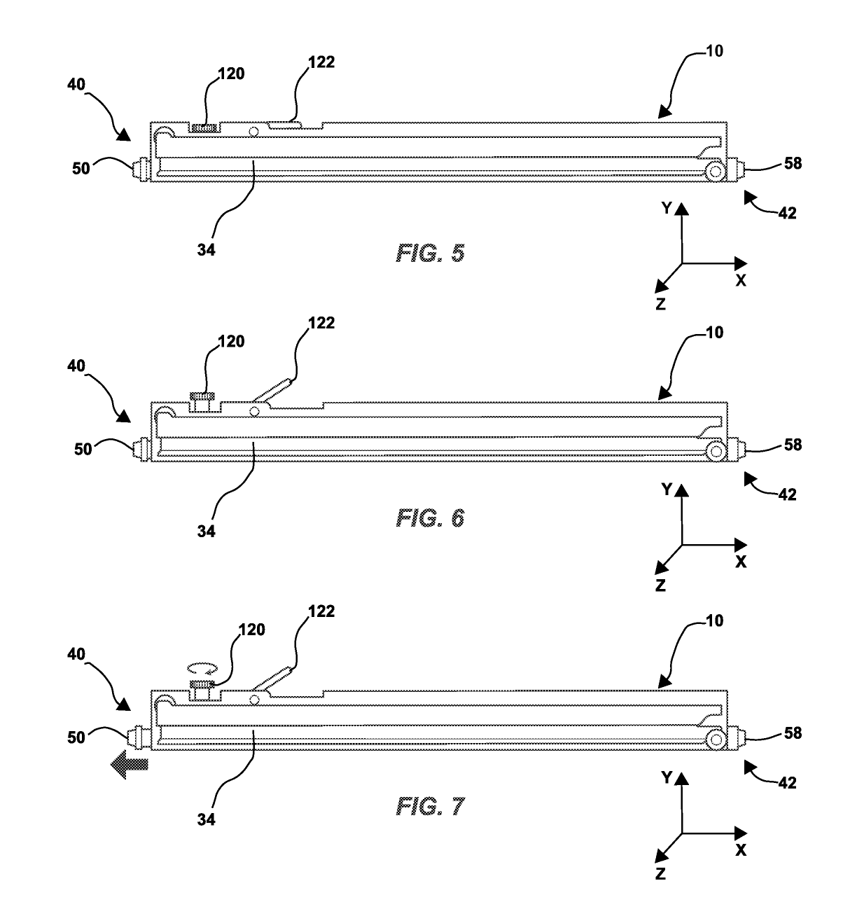

Referring again to FIG. 11, as thumbwheel 120 is rotated about an axis extending through the center of the thumbwheel 120 along a direction substantially parallel to the Y axis, as defined in FIGS. 5-7, an active bevel gear 124 is rotated equally about the same axis extending through the center of the thumbwheel 120 along a direction substantially parallel to the Y axis. As the active bevel gear 124 is rotated, the active bevel gear 124 imparts rotation of a passive bevel gear 126 about a longitudinal axis or an axis extending through the center of the movable adjustment member 44 along a direction substantially parallel to the X axis, as defined in FIGS. 5-7.

The passive bevel gear 126 includes an elongate threaded rod 130 (FIG. 4) extending toward the moveable adjustment member 44. The moveable adjustment member 44 includes a longitudinally-extending, internally threaded bore 132 (FIG. 4) that receives the elongate threaded rod 130, whereby rotation of the passive bevel gear 126 imparts longitudinal translation of the moveable adjustment member 44. The threaded rod 130 rotates equally about the same axis extending through the center of movable adjustment member 44 along a direction substantially parallel to the X axis, as defined in FIGS. 5-7. As the threaded rod 130 of the passive bevel gear 126 rotates, it imparts translation of the threaded bore 132 along the threads of the threaded rod 130.

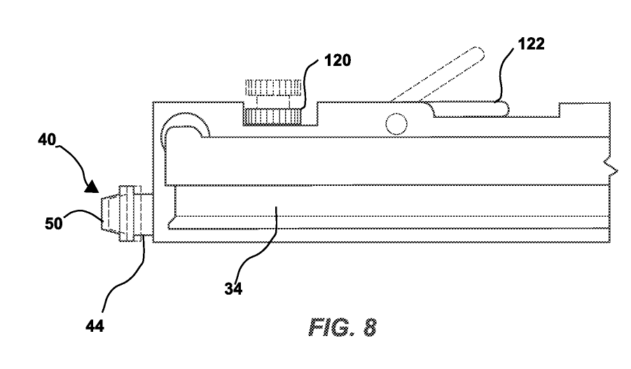

This translation in turn imparts translation of at least one of the first face 40 or the second face 42 of the adjustable stretcher bar housing assembly 10 along a direction substantially parallel with the X axis, as defined in FIGS. 5-7, until at least one of the first face 40 or the second face 42 of the adjustable stretcher bar housing assembly 10 makes contact with the cabinet face frame 16 and the other of the first face 40 or the second face 42 of the adjustable stretcher bar housing assembly 10 makes contact with the cabinet rear wall 18, as illustrated in FIG. 2. The thumbwheel 120 is then rotated further until the adjustable stretcher bar housing assembly 10 is in compression within the cabinet 12. As illustrated in FIG. 8, the thumbwheel 120 is then pushed down to its stowed position.

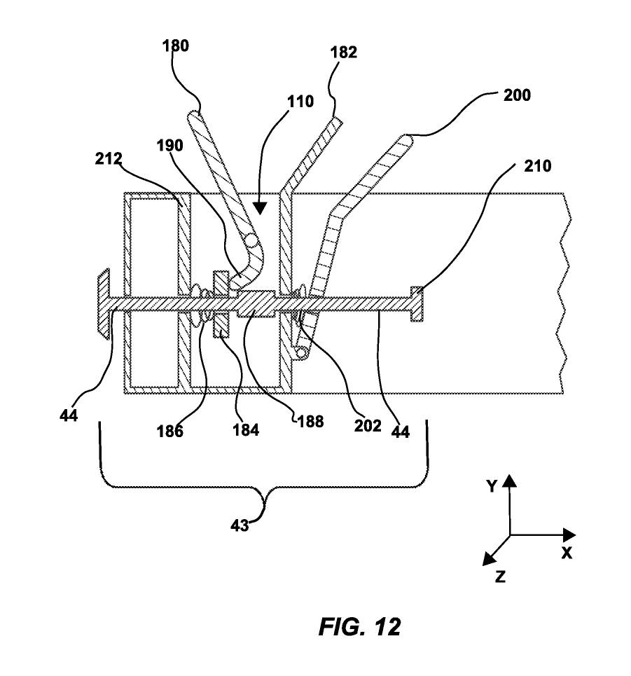

The adjustment system 43 primary translation generating mechanism 110 may also take other forms. For example, the primary translation generating mechanism 110 may be based on the mechanism as illustrated in FIG. 12. Referring to FIG. 12, when an adjustment lever 180 is rotated toward support handle 182, a pushing end 190 of the adjustment lever 180 imparts movement of a binding foot 184. This binding foot 184 is a member that converts rotation of the adjustment lever 180 to longitudinal translation of the movable adjustment member 44.

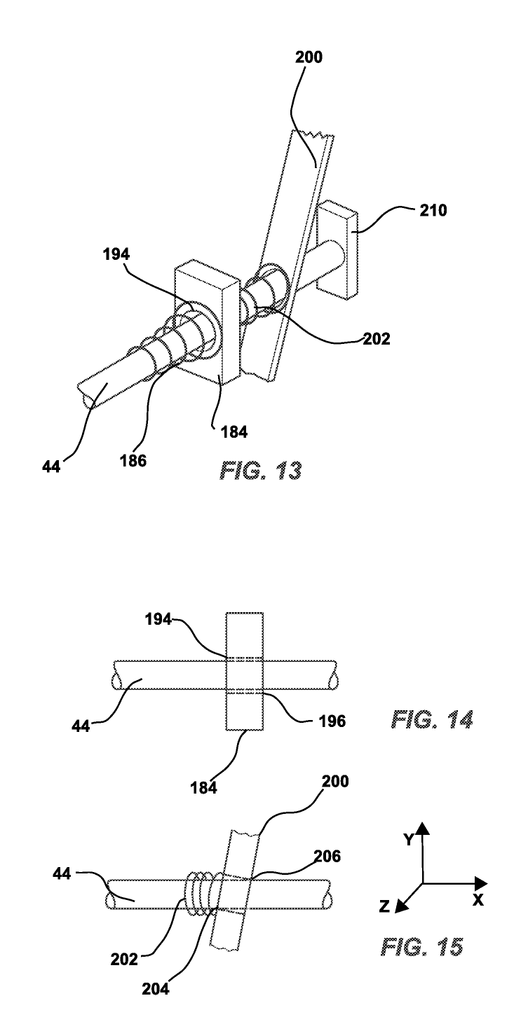

When the pushing end 190 of the adjustment lever 180 makes contact with the binding foot 184, the binding foot 184 rotates until at least one of a first edge 194 (FIG. 13) and a second edge 196 of binding foot 184 makes contact with movable adjustment member 44. As adjustment lever 180 continues to rotate, the interface between the at least one of the first edge 194 and the second edge 196 of binding foot 184 serves to impart translation of the movable adjustment member 44.

Continuing with FIG. 12, binding foot spring 186 biases or helps return the binding foot 184 toward an initial position, as illustrated in FIG. 12, when the force applied to the interface between the pushing end 190 of the adjustment lever 180 and the binding foot 184 is less than the force applied to the binding foot 184 by the binding foot spring 186. This motion causes rotation of the adjustment lever 180 in a direction away from support the handle 182. A binding foot stop 188 limits translation of the binding foot 184 as the binding foot spring 186 returns the binding foot 184 to its initial position.

Referring again to FIG. 12, stop lever 200 helps to prevent translation of the movable adjustment member 44 when the movable adjustment member 44 is not being translated due to the rotation of adjustment lever 180. The stop lever 200, when it is in an initial position as illustrated in FIG. 12, is situated such that at least one of a first stopping edge 204 and a second stopping edge 206 of stop lever 200 makes contact with movable adjustment member 44, as illustrated in FIG. 15. The interface between the at least one of the first stopping edge 204 and the second stopping edge 206 of stop lever 200 helps to prevent translation of the movable adjustment member 44 in a positive direction along a direction substantially parallel to the X axis as defined in a right-hand Cartesian coordinate system, as shown in FIGS. 12-15.

However, as the movable adjustment member 44 is translated in a negative direction along a direction substantially parallel to the X axis as defined in the right-hand Cartesian coordinate system of FIGS. 12-15, the interface between the at least one of the first stopping edge 204 and the second stopping edge 206 of stop lever 200 causes stop lever 200 to rotate away from its initial position. This rotation reduces the force applied to the interface between the at least one of the first stopping edge 204 and the second stopping edge 206 of the stop lever 200 and the movable adjustment member 44, allowing the movable adjustment member 44 to further translate. When movable adjustment member 44 is not being translated, a stop lever spring 202 imparts movement of the stop lever 200 back to the initial position of the stop lever 200. This imparts additional force to the interface between the at least one of the first stopping edge 204 and the second stopping edge 206 of stop lever 200 and the movable adjustment member 44, which, again, prevents translational of the movable adjustment member 44 in a positive direction along a direction substantially parallel to the X axis as defined in the right-hand Cartesian coordinate system of FIGS. 12-15.

A movable adjustment member stop 210 limits the amount by which movable adjustment member 44 may translate in the negative direction along a direction substantially parallel to the X axis as defined in the right-hand Cartesian coordinate system of FIGS. 12-15.

Because a user may not generate sufficient compressive force using the primary translation generating mechanism 110 to cause the adjustable stretcher bar housing assembly 10 to become substantially secured within the cabinet 12, a secondary translation generating mechanism 112 may be beneficial. The secondary translation generating mechanism 112 causes at least one of the first face or the second face of the adjustable stretcher bar housing assembly 10 to further translate, placing the adjustable stretcher bar housing assembly 10 in further compression. This secondary translation generating mechanism 112 may take the form of a locking lever 122, as illustrated in FIG. 3, for example, that is connected to a sub-mechanism that imparts the additional translation.

As illustrated in FIG. 8, the locking lever 122 is pushed down to its stowed position, causing the movable adjustment member 44 to further translate. This further translation generates additional compressive force that helps prevent translation or rotation of the installed adjustable stretcher bar housing assembly 10.

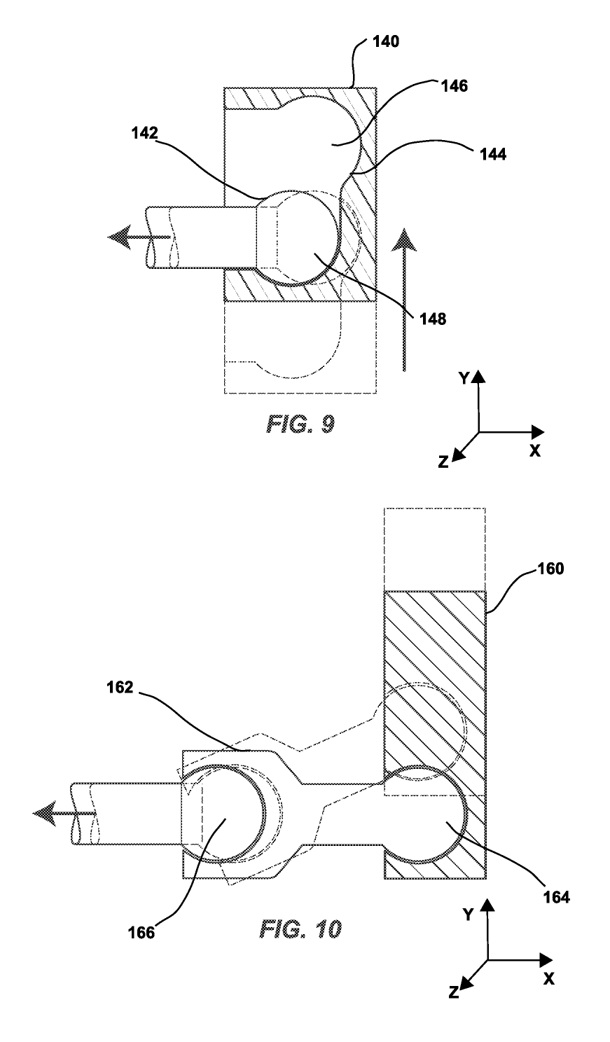

As described in more detail below, FIG. 9 illustrates one embodiment of a locking mechanism used to create the additional translation of the movable adjustment member 44 when the locking lever 122 is moved to its stowed position. FIG. 10 illustrates another embodiment of a locking mechanism.

Referring now to FIG. 9, a stepped cam track translation assembly 140 imparts translation of the movable adjustment member 44 as the stepped cam track translation assembly 140 drives cam ball member 142 along a ramped cam track transition 144 into either a first cam track position 146 or a second cam track position 148. Cam ball member 142, which is part of the assembly connected to the movable adjustment member 44, translates along a direction substantially parallel to the X axis as defined in FIG. 9, as the stepped cam track translation assembly 140 is translated in a direction substantially parallel to the Y axis as defined in FIG. 9.

When stepped cam track translation assembly 140 is in its upper-most position along a direction substantially parallel to the Y axis as defined in FIG. 9, cam ball member 142 is moved to its left-most position along a direction substantially parallel to the X axis. However, when stepped cam track translation assembly 140 is in its lower-most position along a direction substantially parallel to the Y axis as defined in FIG. 9, cam ball member 142 is moved to its right-most position along a direction substantially parallel with the X axis as defined in FIG. 9. This movement imparts additional translation of the movable adjustment member 44, which enhances securement of the adjustable stretcher bar housing assembly into cabinet 12.

Turning to FIG. 10, a second embodiment of the secondary translation mechanism 112 may take the form of a ball joint-based translation-generating mechanism. An example of a ball joint-based translation-generating mechanism is a ball and socket translation generation member 160, which imparts translation of the movable adjustment member 44 as the ball and socket translation generation member 160 translates. In particular, as the ball and socket translation generation member 160 translates in a direction substantially parallel to the Y axis as defined in FIG. 10, the movable adjustment member 44 translates along a direction substantially parallel to the X axis as defined in FIG. 10. For example, when the ball and socket translation generation member 160 is in its upper-most position along a direction substantially parallel to the Y axis as defined in FIG. 10, the movable adjustment member 44 is moved to its right-most position along a direction substantially parallel to the X axis as defined in FIG. 10. Conversely, when the ball and socket translation generation member 160 is in its lower-most position along a direction substantially parallel to the X axis as defined in FIG. 10, the movable adjustment member 44 is moved to its left-most position along a direction substantially parallel to the X axis as defined in FIG. 10.

The ball and socket translation linkage 162 facilitates conversion of translation of the ball and socket translation generation member 160 along a direction substantially parallel to the Y axis as defined in FIG. 10 to translation of the movable adjustment member 44 along a direction substantially parallel to the X axis as defined in FIG. 10. As the ball and socket translation generation member 160 translates, ball and socket translation linkage 162 rotates about an axis going through a point in the center (e.g., the centroid) of the active ball and socket joint 164 along a direction substantially parallel to the Z axis, as defined in FIG. 10.

In particular, as the ball and socket translation generating member 160 moves to its upper-most position along a direction substantially parallel to the Y axis as defined in FIG. 10, ball and socket translation linkage 162 is rotated in a positive direction as defined by a right-hand coordinate system centered at a point in the center of active ball and socket joint 164 (e.g., the centroid) with the coordinate system's X, Y, and Z axes being respectively parallel to the X, Y, and Z axes of the coordinate system as defined in FIG. 10. This rotation also corresponds to a rotation about an axis going through the center (e.g., the centroid) of passive ball and socket joint 166. As the passive ball and socket joint 166 rotates, it also translates. This translation thereby imparts translation of the movable adjustment member 44.

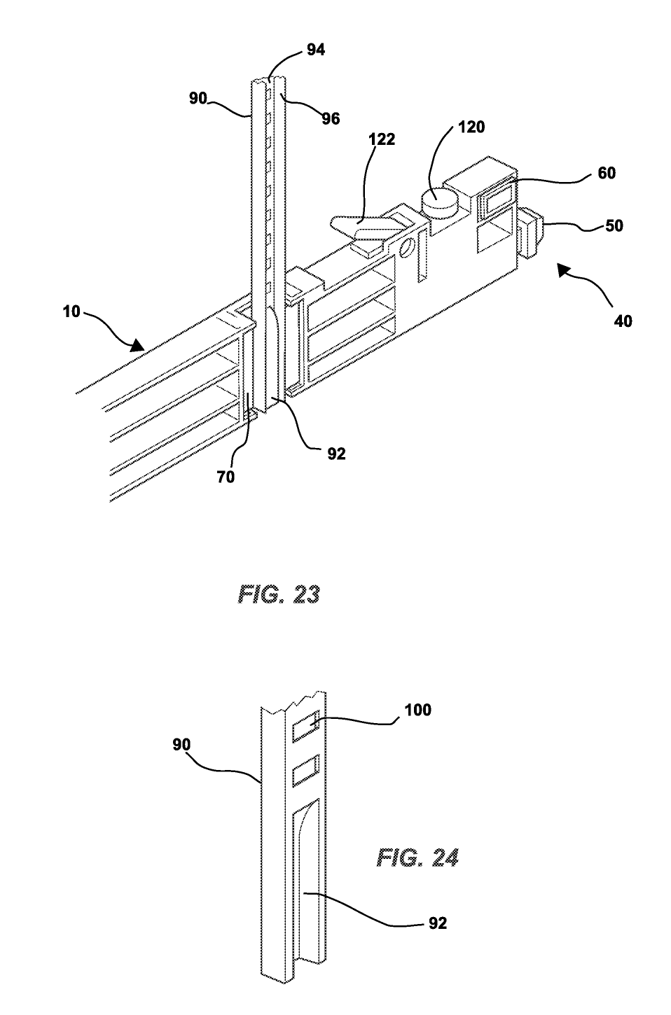

With reference to FIGS. 23-27, to install additional adjustable stretcher bar housing assemblies 10 above the pair of adjustable stretcher bar housing assemblies 10 described previously, upright standard mounting bars 90 are installed in the bottom adjustable stretcher bar housing assemblies 10. When installed, each upright standard mounting bar 90 is substantially perpendicular to the length of the adjustable stretcher bar housing assembly 10.

As illustrated in FIGS. 1, 2, and 26, other adjustable stretcher bar housing assemblies 10 are then connected to the upright standard mounting bars 90 using the hanger hooks 78 on the hanger brackets 70. A drawer slide 34 may be attached to the adjustable stretcher bar housing assemblies 10, as illustrated in FIG. 1, in order to provide an apparatus for sliding a drawer 30 or shelf (not shown) in and out of cabinet 12.

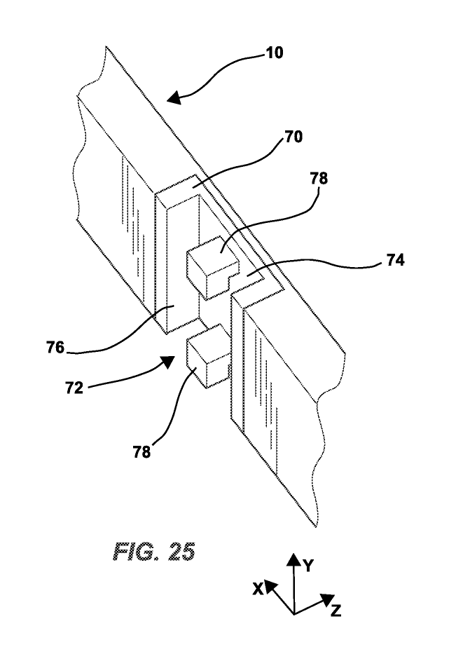

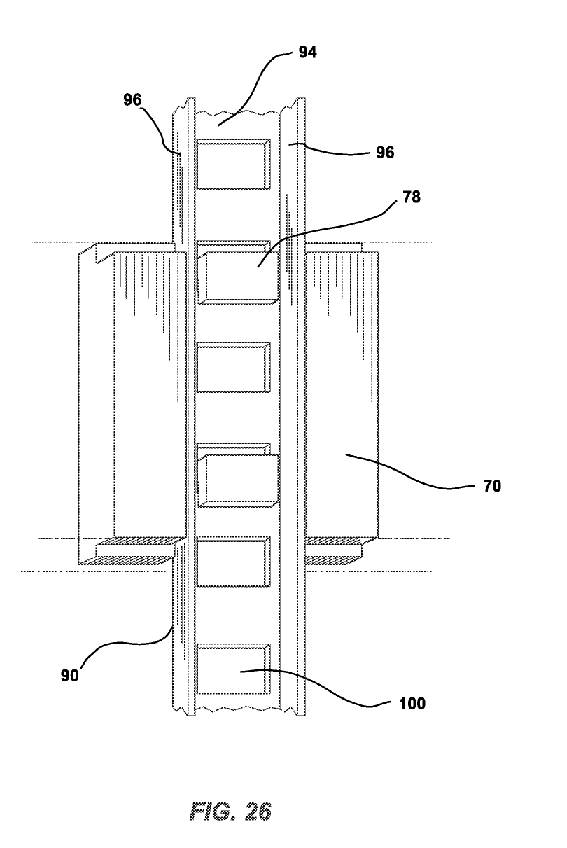

Referring now to FIGS. 23-25, the upright standard mounting bar 90 is installed in a U-shaped hanger bracket channel 72 (FIG. 25) in a space between the cabinet sidewall 20 and hanger bracket 70. The upright standard mounting bars 90 are U-shaped members with side faces 96 and a central face 94. In order to allow the upright standard mounting bar 90 to fit within the U-shaped hanger bracket channel 72 without being obstructed by hanger hooks 78, an upright standard bottom depression 92, as illustrated in FIG. 24, is integrated into upright standard mounting bar 90. The upright standard bottom depression 92 curves away from the upright standard central face 94 in the same direction as the upright standard side faces 96.

Referring now to FIG. 26, upright standard mounting bar windows 100 are disposed vertically along the length of the central face 94 of the upright standard mounting bar 90. These upright standard mounting bar windows 100 provide a method for attaching additional adjustable stretcher bar housing assemblies 10 via hanger hooks 78. As illustrated in FIG. 25, the hanger hooks 78 extend perpendicular from a plane defined by hanger bracket center wall 74. The upright standard mounting bar windows 100 are preferably provided at regular intervals along the length of the central face 94 of the upright standard mounting bar 90. The intervals are small enough to facilitate engagement of the hanger hooks 78 of adjustable stretcher bar housing assemblies 10 at customizable heights, so an installer can easily select and, if desired, modify, the height of one or more drawers or shelves to be received in the cabinet.

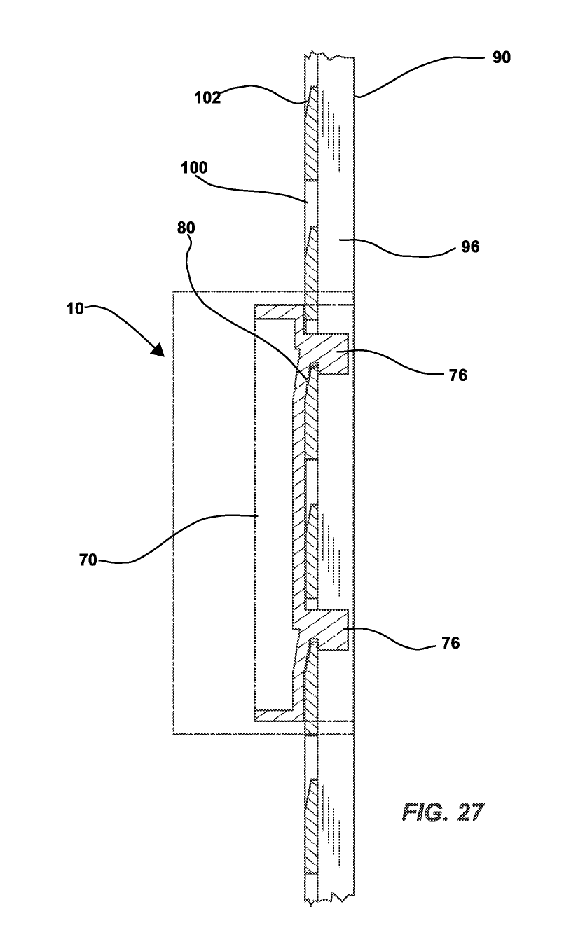

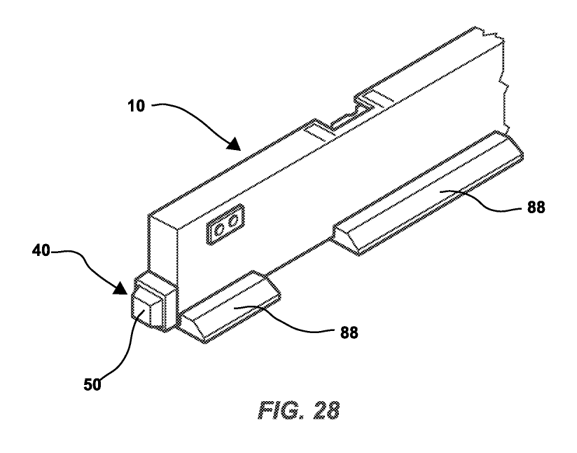

Referring to FIG. 27, the upright standard windows 100 have a sloped window edge 102 disposed at the bottom of the upright standard windows 100, with the sloped window edge 102 extending along the width of the upright standard windows 100. The sloped window edge 102 interfaces with the sloped hanger bracket face 80. The matching sloped surfaces of sloped window edge 102 and sloped bracket face 80 help to assure proper alignment and securement of the hanger hooks 78 and, therefore, provide stable, secure receipt of the adjustable stretcher bar housing assembly 10 within the upright standard windows 100.

In accordance with the present disclosure, the hanger brackets 70 may be allowed to translate slightly along directions parallel to the X, Y, and Z axes as defined in FIG. 10, in order to permit the adjustable stretcher bar housing assembly 10 to compensate for cabinets 12 having walls that are not flat or not perpendicular to one another.

Referring now to FIGS. 17-20, due to surface differences inside the cabinet 12, other embodiments of the mounting pad with resilient material 50 may be beneficial. One example of an alternate embodiment of the front mounting pad with resilient material 50 is a front mounting pad with pointed protrusions 52 (FIG. 18). These protrusions would slightly penetrate the surface of at least one of the cabinet face frame 16 and the cabinet rear wall 18. This may be useful, for example, on surfaces where the coefficient of friction between the mounting pad with resilient material 50 and the at least one of the cabinet face frame 16 and the cabinet rear wall 18 is too low to prevent translation or rotation of the adjustable stretcher bar housing assemblies 10 under a load.

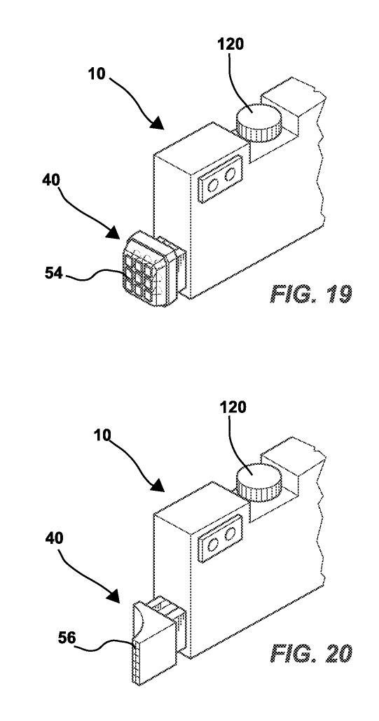

Another embodiment of the front mounting pad with resilient material 50 may be a front mounting pad with pointed protrusions and resilient material 54 (FIG. 19). This may be useful, for example, under the same conditions where the front mounting pad with pointed protrusions 52 are useful. A beneficial aspect of the front mounting pad with pointed protrusions and resilient material 54 may be that the resilient material provides sufficient friction to hold the adjustable stretcher bar housing assembly 10 in place during installation until the pointed protrusions have extended beyond the face of the resilient material and have entered the surface of either the cabinet face frame 16 or the cabinet rear wall 18.

The rear mounting pad 58, as illustrated in FIG. 16, may also incorporate the above described elements of the front mounting pad with pointed protrusions 52 and the front mounting pad with pointed protrusions and resilient material 54.

As illustrated in FIG. 16, stabilizing members 88 may be attached to adjustable stretcher bar housing assembly 10 to help further prevent translation and rotation, particularly rotation, of the bottom adjustable stretcher bar housing assemblies 10 (e.g., under heavy loads transmitted to drawer slide 34). The stabilizing members 88 may be a single-piece support member or a number of support members.

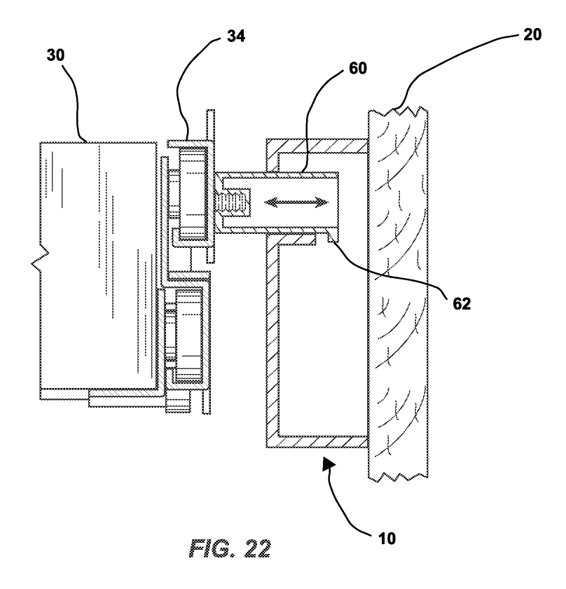

Cabinets 12 are also known to vary in width due to different manufacturing specifications. The adjustable stretcher bar housing assembly 10 is adjustable to compensate for these differences. FIG. 21 illustrates a front, partially broken away view of an adjustable stretcher bar housing assembly 10, as installed on the right side of a cabinet. Here, a drawer slide 34 is physically attached via floating drawer slide mount 60 to the adjustable stretcher bar housing assembly 10 using a method not illustrated, but the method may include machine screws. In FIG. 21, the drawer slide 34 is substantially adjacent to the adjustable stretcher bar housing assembly 10. This would be the case when the distance between the outer drawer walls 32 is substantially similar in size to the width of cabinet opening 14. FIG. 22, however, shows the assembly of FIG. 21 when the distance between the outer drawer walls 32 is substantially smaller in size than the width of cabinet opening 14. Here, floating drawer slide mount 60 would be extended to compensate for this difference in width. A floating drawer slide mount stop 62 helps to keep the floating drawer slide mount 60 inside the adjustable stretcher bar housing assembly 10, as illustrated in FIG. 22.

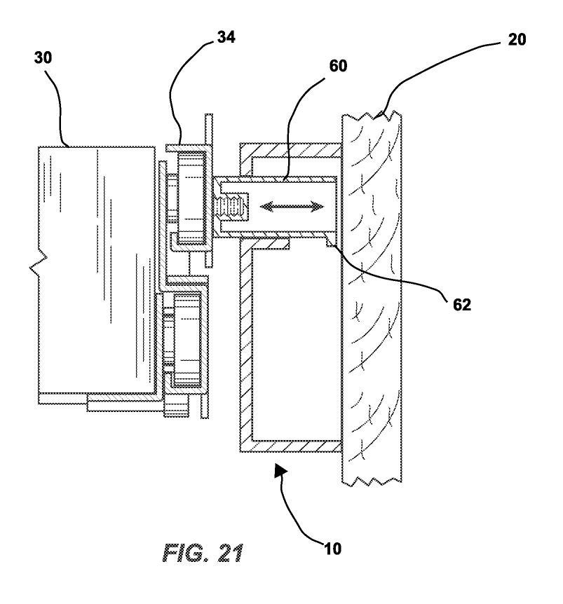

Cabinets 12 are also known to have been built such that there are rounded support members installed between perpendicular walls of the cabinet, particularly between the cabinet face frame 16 and cabinet sidewall 20 and the cabinet rear wall 18 and the cabinet sidewall 20. As illustrated in FIG. 20, a curved front face 56 of the movable adjustment member 44 is suited for such a cabinet, as it provides surface area contact with the rounded support member and wall. This is unlike the front pad with resilient material 50, the front pad with pointed protrusions 52, and the front pad with pointed protrusions and resilient material 54, each of which would not maintain contact with the rounded support member.

While various embodiments have been described above, it is understood that modifications may be made thereto that are still within the scope of the present invention.

We claim:

1. A system for securely installing one or more drawers or shelves in a cabinet, the system comprising:
a set of adjustable stretcher bar housing assemblies having at least one pair of adjustable stretcher bar housing assemblies, wherein each of the adjustable stretcher bar housing assemblies includes a first face adapted to contact one of a rear wall or a face frame of a cabinet, and a second face longitudinally spaced from the first face and adapted to contact the other of the rear wall or the face frame of the cabinet; and
an adjustment system having a primary translation generating mechanism and a movable adjustment member, wherein the primary translation generating mechanism causes the moveable adjustment member to axially extend until at least one of the first face or the second face contacts one of the face frame or the rear wall of the cabinet, thereby placing each adjustable stretcher housing assembly into compression with the cabinet and allowing one or more drawers or shelves to be secured to the cabinet in a tool-free manner.

2. The system of claim 1, wherein the primary translation generating mechanism comprises a thumbwheel, such that rotation of the thumbwheel in a first direction causes one of the first face or the second face to translate longitudinally until one of the first face or the second face contacts the face frame or the rear wall, placing the respective adjustable stretcher bar assembly into compression with the cabinet.

3. The system of claim 2, wherein the primary translation generating mechanism further comprises a bevel gear pair including an active bevel gear and a passive bevel gear, wherein rotation of the active bevel gear imparts rotation of the passive bevel gear about a longitudinal axis of the moveable adjustment member, and the passive bevel gear includes an elongate threaded rod extending toward moveable adjustment member.

4. The system of claim 3, wherein the moveable adjustment member includes a longitudinally-extending, internally threaded bore that receives the elongate threaded rod, whereby rotation of the passive bevel gear imparts longitudinal translation of the moveable adjustment member.

5. The system of claim 1, wherein the primary translation generating mechanism comprises an adjustment lever having a pushing end, a support handle, and a binding foot, wherein upon rotation of the adjustment lever toward the support handle, the pushing end of the adjustment lever imparts movement of the binding foot such that the binding foot converts rotation of the adjustment lever to longitudinal translation of the moveable adjustment member.

6. The system of claim 5, wherein when the pushing end of the adjustment lever contacts the binding foot, the binding foot rotates until at least one of a first edge and a second edge of the binding foot contacts the moveable adjustment member, and, as the adjustment lever continues to rotate, an interface between the at least one of the first edge and the second edge of the binding foot imparts translation of the moveable adjustment member.

7. The system of claim 5, wherein a binding foot spring biases the binding foot toward an initial position when a force applied to an interface between the pushing end of the adjustment lever and the binding foot is less than the force applied to the binding foot by the binding foot spring, thereby causing rotation of the adjustment lever in a direction away from the support handle.

8. The system of claim 1, further comprising a secondary translation generating mechanism that causes at least one of the first face or the second face of the adjustable stretcher bar housing assembly to further translate, placing each adjustable stretcher bar housing assembly into further compression with the cabinet.

9. The secondary translation generating mechanism of claim 8, wherein the secondary translation generating mechanism comprises a locking lever, and wherein, upon pushing the locking lever down to a stowed position, the moveable adjustment member further translates and an additional compressive force that helps prevent translation or rotation of the installed adjustable stretcher bar housing assembly is generated.

10. The system of claim 8, wherein the secondary translation generating mechanism comprises a stepped cam track translation assembly that drives a cam ball member along a ramped cam track transition into either a first cam track position or a second cam track position, and wherein movement of the cam ball member imparts additional translation of the moveable adjustment member, thereby enhancing securement of each adjustable stretcher bar housing assembly into the cabinet.

11. The system of claim 8, wherein the secondary translation generating mechanism comprises a ball joint-based translation-generating mechanism that includes a ball and socket translation member, a ball and socket translation linkage, and a passive ball and socket joint, wherein as the ball and socket translation generating member moves to an upper-most position, the ball and socket translation linkage is rotated in a positive direction, and the passive ball and sock joint rotates and translates, thereby imparting further translation of the moveable adjustment member.

12. The system of claim 1, wherein the first and second faces each include a mounting pad, and wherein each of the mounting pads includes one or more of the group of pointed protrusions, resilient material, pointed protrusions embedded inside of a resilient material or a curved material.

13. The system of claim 1, further comprising a drawer slide attached to each adjustable stretcher bar housing assembly to provide an apparatus for sliding a drawer or shelf in and out of the cabinet.

14. The system of claim 1, wherein each adjustable stretcher bar housing assembly includes one or more U-shaped channels including one or more hanger hooks for engaging mounting bar windows provided along an upright standard mounting bar, thereby allowing the installation of additional adjustable stretcher bar assemblies disposed above the pair of adjustable stretcher bar housing assemblies.

15. A method for securely installing one or more drawers or shelves in a cabinet, the method comprising:
placing a pair of adjustable stretcher bar housing assemblies into a bottom portion of the cabinet, wherein each adjustable stretcher bar housing assembly includes a first face adapted to contact one of a rear wall or a face frame of the cabinet, and a second face adapted to contact one of the rear wall or the face frame of the cabinet; and
operating an adjustment system having a primary translation generating mechanism and a movable adjustment member, wherein the primary translation generating mechanism causes the moveable adjustment member to axially extend until at least one of the first face or the second face contacts one of the face frame or the rear wall of the cabinet, thereby placing the associated adjustable stretcher housing assembly into compression with the cabinet.

16. The method of claim 15, wherein the primary translation generating mechanism comprises a thumbwheel, the method further comprising rotating the thumbwheel in a direction that causes at least one of the first face or the second face to translate until one of the first face or the second face contacts the face frame or the rear wall of the cabinet, thereby placing each adjustable stretcher bar housing assembly in compression with the cabinet.

17. The method of claim 16, wherein in rotating the thumbwheel, the rotation of the thumbwheel imparts rotation to an active bevel gear, the active bevel gear in driving communication with a passive bevel gear, the passive bevel gear including an elongate threaded rod extending toward the moveable adjustment member, and the movable adjustment member including a longitudinally extending internally threaded bore that receives the elongate threaded rod, whereby rotating the thumbwheel imparts longitudinal translation of the movable adjustment member.

18. The method of claim 15, wherein the primary translation generating mechanism comprises an adjustment lever having a pushing end, a support handle, and a binding foot, the method further comprising rotating the adjustment lever toward the support handle, causing the pushing end of the adjustment lever to impart movement of the binding foot such that the binding foot converts rotation of the adjustment lever to translation of the moveable adjustment lever.

19. The method of claim 15, the method further comprising operating a secondary translation generating mechanism that causes at least one of the first face or the second face of each adjustable stretcher bar housing assembly to further translate, thereby placing the adjustable stretcher bar housing assemblies in further compression with the cabinet.

20. The method of claim 19, wherein operating a secondary translation generating mechanism comprises pushing down a locking lever to a stowed position, thereby generating further translation of the moveable adjustment member and an additional compressive force that increases securement of the installed adjustable stretcher bar housing assemblies against at least one of translation or rotation.

21. The method of claim 15, further comprising:
inserting an upright standard mounting bar into a U-shaped hanger bracket channel disposed on each of the adjustable stretcher bar housing assemblies disposed within the bottom portion of the cabinet; and
connecting an additional adjustable stretcher bar housing assembly to each of the upright standard mounting bars using one or more hanger hooks disposed through upright standard mounting bar windows of the upright standard mounting bars.

22. The method of claim 15, wherein the upright standard mounting bar windows are provided at regular intervals along the length of each upright standard mounting bar.

23. The method of claim 15, further comprising attaching a drawer slide to at least one of the adjustable stretcher bar housing assemblies to provide an apparatus for sliding the drawer or shelf in and out of the cabinet.

24. A method of installing additional adjustable stretcher bar housing assemblies to a pair of adjustable stretcher bar housing assemblies disposed within a bottom portion of a cabinet, the method comprising:
inserting an upright standard mounting bar into a U-shaped hanger bracket channel disposed on each of the adjustable stretcher bar housing assemblies;
engaging at least one hanger hook disposed within the U-shaped hanger bracket channel of each of the adjustable stretcher bar housing assemblies into at least one upright standard mounting bar window disposed on the upright standard mounting bar;
connecting an additional adjustable stretcher bar housing assembly to the hanger hook engaged to the upright standard mounting bar window of each of the adjustable stretcher bar housing assemblies disposed within the bottom portion of the cabinet,
thereby allowing one or more additional drawers or shelves to be installed within the cabinet.

25. The method of claim 24, wherein each hanger hook extends perpendicular from a plane defined by a hanger bracket center wall of a hanger bracket.

26. The method of claim 24, wherein each upright standard mounting bar is U-shaped with side faces and a central face.

27. The method of claim 26, wherein each upright standard mounting bar includes an upright standard bottom depression that curves away from the central face, thereby allowing each upright standard mounting bar to be inserted within the U-shaped hanger bracket channel without being obstructed by one or more hanger hooks.

28. The method of claim 26, wherein the upright standard mounting bar windows are provided at regular intervals along the length of the central face of each upright standard mounting bar.
